(19) United States
(12) Patent Application Publication
(10) Pub. No.: US 2010/0053455 A1
(43) Pub. Date: Mar. 4, 2010

(54) BACKLIGHT DEVICE, DISPLAY APPARATUS, AND TELEVISION RECEIVER

(75) Inventors: Kentaro Kamada, Osaka-shi (JP); Yasumori Kuromizu, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/513,168

(22) PCT Filed: Jun. 13, 2007
(86) PCT No.: PCT/JP2007/061911

§ 371 Date: May 1, 2009

(30) Foreign Application Priority Data
Nov. 29, 2006 (JP) 2006-321169

(51) Int. Cl. H04N 5/44; G02F 1/13357; G09G 5/02

(52) U.S. Cl. 348/725; 362/97.1; 345/697; 348/E05.096

(57) ABSTRACT

In a backlight device including a plurality of cold cathode fluorescent tubes, a pitch of the cold cathode fluorescent tube provided on one end in a direction perpendicular to the longitudinal directions of the cold cathode fluorescent tubes with respect to a center line passing through a center in the perpendicular direction of a diffusion plate is differentiated from a pitch of the cold cathode fluorescent tube provided on the other end in the perpendicular direction with respect to the center line.

### BACKGROUND OF THE INVENTION

1. Field of the Invention

The present invention relates to a backlight device, in particular, a backlight device having linear light sources such as cold cathode fluorescent tubes, and a display apparatus and a television receiver using the same.

2. Description of the Related Art

Recently, for example, in a household television receiver, a display apparatus including a liquid crystal panel as a flat display portion with a number of features such as thinness and a light weight compared with conventional cathode ray tubes, as typified by a liquid crystal display apparatus, is becoming a mainstream. Such a liquid crystal display apparatus includes a backlight device emitting light and the liquid crystal panel displaying a desired image by playing a role of a shutter with respect to light from a light source provided in the backlight device. Then, a television receiver displays information such as characters and images contained in video signals of a television broadcast on a display surface of the liquid crystal panel.

Furthermore, the above-mentioned backlight device is classified roughly into a direct type and an edge-light type depending upon the arrangement of the light source with respect to the liquid crystal panel. A liquid crystal display apparatus having a liquid crystal panel of 20 inches or more generally uses the direct type backlight device that can achieve the increase in brightness and enlargement more easily than the edge-light type backlight device. More specifically, in the direct type backlight device, a plurality of linear light sources are disposed on a rear side (non-display surface) of the liquid crystal panel, and the linear light sources can be arranged right on a reverse side of the liquid crystal panel, which enables a number of linear light sources to be used. Thus, the direct type backlight device can obtain high brightness easily, and is suitable for the increase in brightness and enlargement. Furthermore, the direct type backlight device has a hollow structure, and hence, is light-weight even when enlarged. This also allows the direct type backlight device to be suitable for the increase in brightness and enlargement.

Furthermore, in the direct type backlight device, generally, a plurality of cold cathode fluorescent tubes as linear light sources are arranged so as to be parallel to each other at a constant pitch, and light emitted from the cold cathode fluorescent tubes is output to the above-mentioned liquid crystal panel as flat plane-shaped light from a light-emitting surface opposed to the liquid crystal panel.

On the other hand, in the liquid crystal display apparatus, brightness at a center position of the liquid crystal panel is measured, and the brightness performance in the liquid crystal display apparatus generally is evaluated based on the measurement results. Therefore, in the backlight device, there is a demand for enhancing the brightness at the above-mentioned center position.

For example, as described in JP 2004-287226 A, in a conventional backlight device, a plurality of cold cathode fluorescent tubes are arranged so that the pitch thereof decreases toward the center of the light-emitting surface and increases toward the peripheral side. Furthermore, in the conventional example, it also is proposed that a plurality of cold cathode fluorescent tubes are arranged at the above pitch so that they are symmetric vertically with respect to a center line passing through the center of the light-emitting surface, which enables the increase in brightness and the elimination of brightness unevenness at the center position.

However, in the conventional backlight device as described above, there is a problem that brightness unevenness occurs in the above-mentioned plane-shaped light emitted from the light-emitting surface to the liquid crystal panel (outside), depending upon the use environment such as a use state and an ambient temperature, or the setting number and kind of cold cathode fluorescent tubes.

Specifically, for example, in the household television receiver, the display surface generally is set to be parallel to the working direction of the gravity (vertical direction), and therefore, in the conventional backlight device, the light-emitting surface provided so as to be parallel to the display surface also is set to be parallel to the vertical direction. Furthermore, in the conventional backlight device, a plurality of cold cathode fluorescent tubes are housed in a housing, and further, in order to prevent mercury sealed in the cold cathode fluorescent tubes from being concentrated on a lower side in the vertical direction due to the gravity, a plurality of cold cathode fluorescent tubes are arranged in a row in the vertical direction in the housing while the longitudinal direction of the cold cathode fluorescent tubes is kept parallel to the direction perpendicular to the vertical direction. Therefore, in the conventional backlight device, when the cold cathode ray tubes are lit, a temperature gradient in the vertical direction in the housing, i.e., a temperature difference between the upper portion and the lower portion of the housing occurs.

On the other hand, in the cold cathode fluorescent tubes as described above, an emission efficiency changes in accordance with the vapor pressure of mercury sealed therein, and an emission amount also changes. Therefore, when the temperature difference occurs in the housing as described above in the conventional backlight device, the ambient temperature varies in a plurality of cold cathode fluorescent tubes, depending upon the setting place in the housing, and the vapor pressure of mercury also varies. Consequently, in the conventional backlight device, the emission efficiencies of a plurality of cold cathode fluorescent tubes vary, and the emission amounts thereof become non-uniform, which results in brightness unevenness.

In particular, in the case where the setting number of cold cathode fluorescent tubes is reduced in accordance with a request for decreasing a cost in the liquid crystal display apparatus, a pitch is enlarged in the cold cathode fluorescent tubes, whereby brightness unevenness is likely to occur in the conventional backlight device.

### SUMMARY OF THE INVENTION

In view of the above problems, preferred embodiments of the present invention provide a backlight device capable of preventing the occurrence of brightness unevenness easily, and a display apparatus and a television receiver including the same.

A backlight device according to a preferred embodiment of the present invention includes a plurality of linear light sources and a light-emitting surface emitting light from the linear light sources, wherein the plurality of linear light sources respectively are arranged so that longitudinal directions thereof are parallel to each other, and the plurality of linear light sources are arranged in such a manner that a pitch of the linear light source provided on one end in a direction that is perpendicular or substantially perpendicular to the longitudinal directions with respect to a center line passing through a center in the perpendicular direction of the light-emitting surface is differentiated from a pitch of the linear light source provided on the other end in the perpendicular direction with respect to the center line.

In the backlight device configured as described above, a plurality of linear light sources are arranged such that the pitch of the linear light source provided on one end in the perpendicular direction with respect to the center line of the light-emitting surface is differentiated from the pitch of the linear light source provided on the other end in the perpendicular direction with respect to the center line. That is, unlike the above-mentioned conventional example in which a plurality of linear light sources are arranged uniformly at a predetermined pitch, a plurality of linear light sources can be arranged at appropriate pitches, respectively, in accordance with the use environment and the setting number of the linear light sources or the like, whereby the respective emission amounts of the plurality of linear light sources can be made uniform easily. Consequently, unlike the conventional example, the occurrence of brightness unevenness in light emitted toward the outside can be prevented easily.

Furthermore, in the above-mentioned backlight device, it is preferred that the plurality of linear light sources respectively are arranged in a row in the perpendicular direction so as to be parallel or substantially parallel to the light-emitting surface.

In this case, the pitches of the linear light sources can be determined simply, whereby the occurrence of brightness unevenness can be prevented more easily.

Furthermore, it is preferred that the above-mentioned backlight device includes a lighting circuit for lighting the plurality of linear light sources, wherein pitches of the plurality of linear light sources are determined using a temperature distribution when the linear light sources are lit by the lighting circuit and emission characteristics of the linear light sources.

In this case, a plurality of linear light sources respectively are provided more appropriately under the condition that the above-mentioned temperature distribution and emission characteristics are understood in the backlight device. Therefore, the occurrence of brightness unevenness can be prevented more easily and more exactly.

Furthermore, in the above-mentioned backlight device, the pitches of the plurality of linear light sources may be determined using the temperature distribution including a temperature increase caused by heat generated by an external device and the emission characteristics of the linear light sources.

In this case, since the adverse effects of the change in an ambient temperature caused by the heat generated by the external device can be eliminated exactly, the occurrence of brightness unevenness can be prevented more easily and more exactly.

Furthermore, in the above-mentioned backlight device, a housing containing the plurality of linear light sources may be used, and the pitches of the plurality of linear light sources may be determined using the temperature distribution including a temperature decrease caused by a cooling device provided inside the housing and the emission characteristics of the linear light sources.

In this case, a plurality of linear light sources respectively can be provided more appropriately while the temperature decrease caused by the cooling device is understood, and the occurrence of brightness unevenness can be prevented more easily and more exactly.

Furthermore, in the above-mentioned backlight device, a housing containing the plurality of linear light sources may be used, and the pitches of the plurality of linear light sources may be determined using the temperature distribution including a temperature decrease caused by a cooling device provided outside the housing and the emission characteristics of the linear light sources.

In this case, a plurality of linear light sources respectively can be provided more appropriately while the temperature decrease caused by the cooling device is understood, and the occurrence of brightness unevenness can be prevented more easily and more exactly.

Furthermore, in the above-mentioned backlight device, a housing containing the plurality of linear sources may be used, and the pitches of the plurality of linear light sources may be determined using the temperature distribution including a temperature decrease caused by a cooling device attached to an outside surface of the housing and the emission characteristics of the linear light sources.

In this case, a plurality of linear light sources respectively can be provided more appropriately while the temperature decrease caused by the cooling device is understood, and the occurrence of brightness unevenness can be prevented more easily and more exactly.

Furthermore, in the above-mentioned backlight device, each of the plurality of linear light sources may be a cold cathode fluorescent tube or a hot cathode fluorescent tube.

In this case, a backlight device with less power consumption can be configured easily at a low cost.

Furthermore, in the above-mentioned backlight device, it is preferred that each of the plurality of linear light sources is a cold cathode fluorescent tube with a diameter of about 3 mm to about 4 mm, for example.

In this case, the cold cathode fluorescent tube having an excellent emission efficiency is used as each linear light source, so that a backlight device with less power consumption can be configured more easily at a low cost.

Furthermore, in the above-mentioned the backlight device, it is preferred that each of the plurality of linear light sources is a hot cathode fluorescent tube with a diameter of about 5 to about 26 mm, for example.

In this case, the hot cathode fluorescent tube having an excellent emission efficiency is used as each linear light source, so that a backlight device with less power consumption can be configured more easily at a low cost.

Furthermore, in the above-mentioned backlight device, a plurality of light-emitting diodes arranged linearly in a row may be used as each of the plurality of linear light sources.

In this case, even in a backlight device in which the above-mentioned light-emitting surface is relatively small, the above-mentioned occurrence of brightness unevenness can be prevented easily, and a backlight device capable of enlarging a color reproducing range can be configured easily.

Furthermore, in the above-mentioned backlight device, as the plurality of linear light sources, cold cathode fluorescent tubes or hot cathode fluorescent tubes, and a plurality of light-emitting diodes arranged linearly in a row may be arranged alternately by one row or by a plurality of rows.

In this case, a backlight device capable of enlarging a color reproducing range can be configured more easily.

Furthermore, in the above-mentioned backlight device, the lighting circuit may light the plurality of linear light sources sequentially in a direction from one end to the other end or from the other end to one end of the perpendicular direction.

In this case, a backlight device capable of performing so-called scan drive, in which a plurality of linear light sources respectively are lit sequentially in the above direction, is configured.

Furthermore, in the above-mentioned backlight device, the lighting circuit may light each linear light source by supplying current values different from each other to the plurality of linear light sources, respectively.

In this case, the respective emission amounts of a plurality of linear light sources can be made uniform more easily and the occurrence of brightness unevenness can be prevented more simply.

Furthermore, in the above-mentioned backlight device, it is preferred that an optical member that provides predetermined emission characteristics with respect to light emitted from the light-emitting surface is provided above the light-emitting surface.

In this case, a backlight device excellent in light-emitting quality can be configured easily.

Furthermore, a display apparatus according to another preferred embodiment of the present invention preferably includes any of the above-mentioned backlight devices.

The display apparatus configured as described above can use a backlight device capable of preventing the occurrence of brightness unevenness easily, so that a display apparatus in which the degradation in display quality is prevented can be configured easily.

Furthermore, a television receiver according to a further preferred embodiment of the present invention preferably includes the above-mentioned display apparatus.

The television receiver configured as described above includes a display apparatus in which the degradation in display quality is prevented, so that a high-performance television receiver can be configured easily.

According to various preferred embodiments of the present invention, a backlight device capable of preventing the occurrence of brightness unevenness easily, and a display apparatus and a television receiver including the same are provided.

Other features, elements, arrangements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view illustrating a television receiver and a liquid crystal display apparatus according to Preferred Embodiment 1 of the present invention.

FIG. 2 is a view illustrating the configurations of main portions of the liquid crystal display apparatus.

FIG. 3 is a diagram illustrating a specific arrangement, brightness distribution, and temperature distribution of specific cold cathode fluorescent tubes in a backlight device shown in FIG. 2.

FIG. 4 is a graph showing specific emission characteristics of cold cathode fluorescent tubes.

FIG. 5 is a view illustrating the configurations of main portions of a liquid crystal display apparatus according to Preferred Embodiment 2 of the present invention.

FIG. 6 is a diagram illustrating a specific arrangement, brightness distribution, and temperature distribution of a cold cathode fluorescent tube in a backlight device shown in FIG. 5.

FIG. 7 is a view illustrating the configurations of main portions of a liquid crystal display apparatus according to Preferred Embodiment 3 of the present invention.

FIG. 8 is a view illustrating the configurations of main portions of a liquid crystal display apparatus according to Preferred Embodiment 4 of the present invention.

FIG. 9 is a view illustrating the configurations of main portions of a liquid crystal display apparatus according to Preferred Embodiment 5 of the present invention.

FIG. 10 is a view illustrating the configurations of main portions of a backlight device according to Preferred Embodiment 6 of the present invention.

FIG. 11 is a view illustrating the configurations of main portions of a backlight device according to Preferred Embodiment 7 of the present invention.

### DETAILED DESCRIPTION OF THE PREFERRED EMBODIMENTS

Hereinafter, preferred embodiments of a backlight device of the present invention, and a display apparatus and a television receiver including the same will be described with reference to the drawings. In the following description, the case where the present invention is applied to a transmission type liquid crystal display apparatus will be illustrated.

### Preferred Embodiment 1

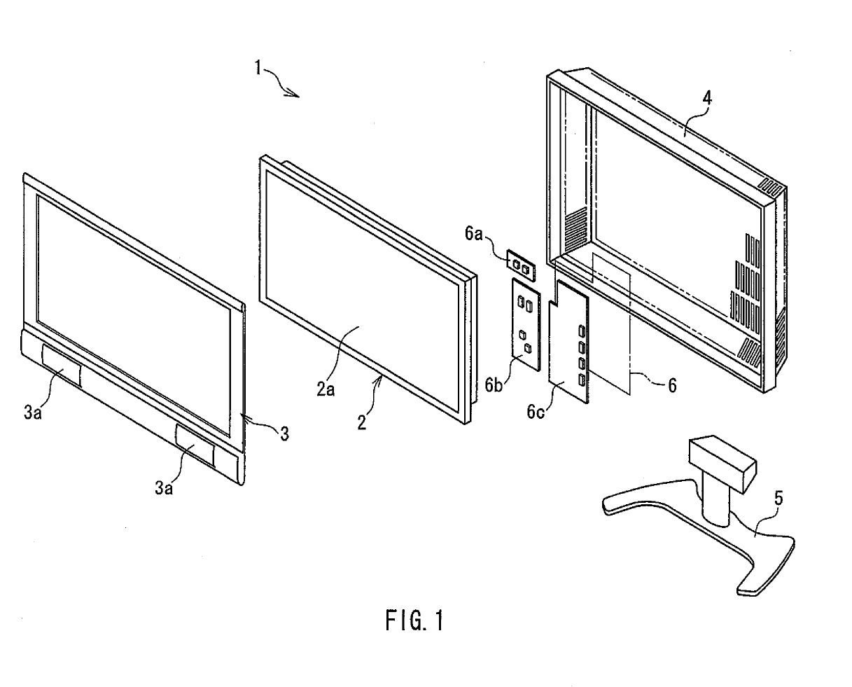

FIG. 1 is an exploded perspective view illustrating a television receiver and a liquid crystal display apparatus according to Preferred Embodiment 1 of the present invention. In the figure, a television receiver 1 of the present preferred embodiment includes a liquid crystal display apparatus 2 as a display apparatus, and is configured so as to be able to receive a television broadcast from an antenna or a cable (not shown). A stand 5 allows the liquid crystal display apparatus 2 to stand up under the condition that the liquid crystal display apparatus 2 is housed in a front cabinet 3 and a back cabinet 4. Furthermore, in the television receiver 1, a display surface 2a of the liquid crystal display apparatus 2 is configured so as to be recognized visually through the front cabinet 3. The display surface 2a is arranged so as to be parallel or substantially parallel to the working direction of the gravity (vertical direction).

Furthermore, in the television receiver 1, a TV tuner circuit board 6a, a control circuit board 6b controlling each portion of the television receiver 1 such as a backlight device described later, and a power supply circuit board 6c, which are to be attached to a support plate 6, are arranged between the liquid crystal display apparatus 2 and the back cabinet 4. Then, in the television receiver 1, an image in accordance with a video signal of a television broadcast received by a TV tuner on the TV tuner circuit board 6a is displayed on the display surface 2a, and sounds are reproduced and output from speakers 3a provided on the front cabinet 3. The back cabinet 4 is provided with a number of vent holes, which are capable of releasing heat generated in the backlight device, a power supply, and the like appropriately.

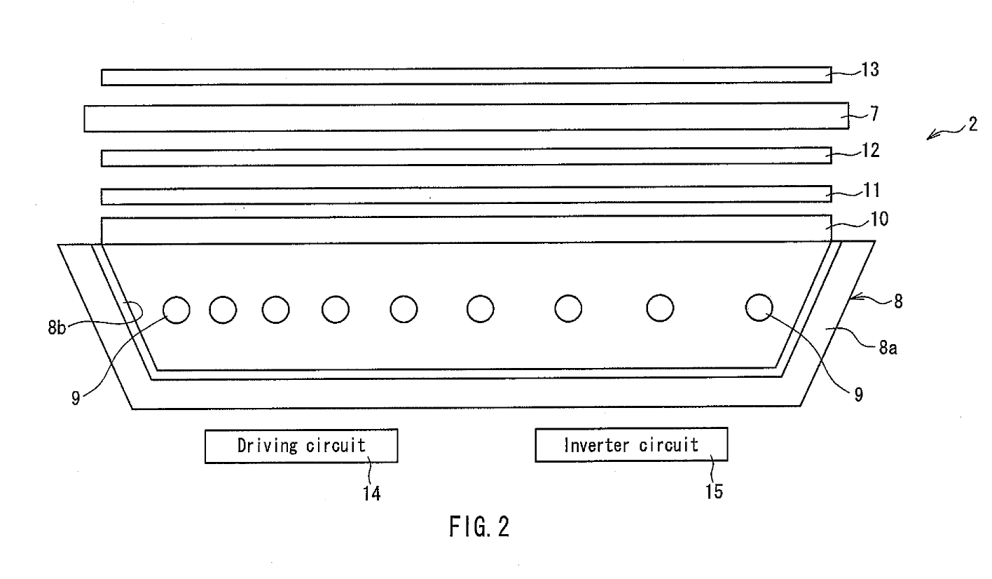

Next, the liquid crystal display apparatus 2 will be described specifically with reference to FIG. 2.

FIG. 2 is a view illustrating the configurations of main portions of the liquid crystal display apparatus. In the figure, the liquid crystal display apparatus 2 is provided with a liquid crystal panel 7 as a display portion that displays information such as characters and images, and a backlight device 8 that is arranged on a non-display surface side (lower side in the figure) of the liquid crystal panel 7 and generates illumination light illuminating the liquid crystal panel 7. The liquid crystal panel 7 and the backlight device 8 are integrated as the transmission type liquid crystal display apparatus 2. Furthermore, in the liquid crystal display apparatus 2, a pair of polarizing plates 12 and 13 with transmission axes arranged in crossed-Nicols are arranged on the non-display surface side and the display surface side of the liquid crystal panel 7, respectively.

The backlight device 8 includes a bottom casing 8a and a plurality of (for example, nine) cold cathode fluorescent tubes 9 as linear light sources housed in the casing 8a as a housing. On the inner surface of the casing 8a, for example, a reflective sheet 8b is provided, which reflects light from the cold cathode fluorescent tubes 9 to the liquid crystal panel 7 side, thereby enhancing the light utilization efficiency of the cold cathode fluorescent tubes 9.

Furthermore, a driving circuit 14 arranged to drive the liquid crystal panel 7 and an inverter circuit 15 arranged to light each of the plurality of cold cathode fluorescent tubes 9 at a high frequency by inverter driving are provided outside the casing 8a. The driving circuit 14 and the inverter circuit 15 constitute an external device of the backlight device 8 and a lighting circuit, respectively. Furthermore, the driving circuit 14 and the inverter circuit 15 are both provided on the control circuit board 6b (FIG. 1) so as to be opposed to the outside of the casing 8a.

Furthermore, the backlight device 8 has a diffusion plate 10 arranged so as to cover the opening of the casing 8a and an optical sheet 11 as an optical member disposed above the diffusion plate 10. The diffusion plate 10 is preferably formed of, for example, a rectangular synthetic resin or glass material with a thickness of about 2 mm, and diffuses light (including the light reflected by the reflective sheet 8b) from the cold cathode fluorescent tubes 9 to output it to the optical sheet 11 side. Furthermore, the diffusion plate 10 is held on the casing 8a so as to be movable, and can absorb deformation by moving on the casing 8a, even when the diffusion plate 10 is (plastically) deformed by expanding/contracting due to the influence of the heat generated by the cold cathode fluorescent tubes 9 and the heat such as the increase in temperature in the casing 8a.

Furthermore, the diffusion plate 10 is configured in such a manner that the surface thereof on the liquid crystal panel 7 side functions as a light-emitting surface of the backlight device 8, and a plurality of cold cathode fluorescent tubes 9 are arranged in a row in parallel to the light-emitting surface on the casing 8a side of the diffusion plate 10. Furthermore, each of the cold cathode fluorescent tubes 9 is arranged so that the longitudinal direction thereof is parallel to the transverse direction of the display surface 2a (FIG. 1), and a plurality of cold cathode fluorescent tubes 9 are arranged in a direction perpendicular or substantially perpendicular to the longitudinal direction, i.e., in the vertical direction of the display surface 2a.

Furthermore, as described in detail later, in the plurality of cold cathode fluorescent tubes 9, the intervals between the respective two adjacent cold cathode fluorescent tubes 9 are set to be different values; that is, the pitch of the cold cathode fluorescent tubes 9 varies, so that the occurrence of brightness unevenness in plane-shaped light emitted toward the liquid crystal panel 7 (outside) can be minimized. As an alternative to the above description, for example, the opening surface in a rectangular shape in the opening of the casing 8a may be used as the light-emitting surface of the backlight device 8.

The optical sheet 11 includes a diffusion sheet formed of, for example, a synthetic resin film with a thickness of about 0.2 mm, and diffuses the above-mentioned illumination light to the liquid crystal panel 7 appropriately to enhance the display quality on the display surface of the liquid crystal panel 7. Furthermore, on the optical sheet 11, a known optical sheet material, which enhances the display quality on the display surface of the liquid crystal panel 7, such as a prism sheet or a polarization reflective sheet is laminated appropriately, if required. Then, the optical sheet 11 converts the plane-shaped light output from the diffusion plate 10 into plane-shaped light having a predetermined brightness (e.g., 10,000 cd/m²) or more and substantially uniform brightness and allows the resultant light to be incident upon the liquid crystal panel 7 side as illumination light.

As an alternative to the above description, for example, an optical member such as a diffusion sheet or the like for adjusting the viewing angle of the liquid crystal panel 7 may be laminated appropriately above (display surface side) the liquid crystal panel 7. More specifically, the optical sheet (optical member) 11 providing predetermined emission characteristics with respect to light emitted from the light-emitting surface may be provided above the light-emitting surface. The use of such an optical member can enhance the front surface brightness in the illumination light and/or adjust the brightness distribution in the illumination light, whereby the backlight device 8 that is excellent in emission quality can be configured easily.

As each cold cathode fluorescent tube 9, a straight tube is preferably used, and electrode portions (not shown) provided at both ends thereof are supported outside the casing 8a. Furthermore, as each cold cathode fluorescent tube 9, a narrowed tube excellent in an emission efficiency with a diameter of about 3.0 mm to about 4.0 mm is preferably used, and each cold cathode fluorescent tube 9 is held inside the casing 8a by a light source holder (not shown) under the condition that the respective distances between the cold cathode fluorescent tubes 9 and the diffusion plate 10 and between the cold cathode fluorescent tubes 9 and the reflective sheet 8b are kept to be predetermined ones. Furthermore, the cold cathode fluorescent tubes 9 are arranged so that the longitudinal direction thereof is parallel to the direction perpendicular to the working direction of the gravity. Thus, in the cold cathode fluorescent tubes 9, mercury (vapor) sealed therein is prevented from being concentrated on one end in the longitudinal direction due to the action of the gravity, and the lamp life is prolonged remarkably.

Furthermore, in the cold cathode fluorescent tubes 9, the pitch of the cold cathode fluorescent tube 9 on the uppermost side of the light-emitting surface is set to be maximum, and the pitch is decreased gradually toward the lower side of the light-emitting surface, using the temperature distribution during the use of the television receiver 1 and the emission characteristics of the cold cathode fluorescent tubes 9.

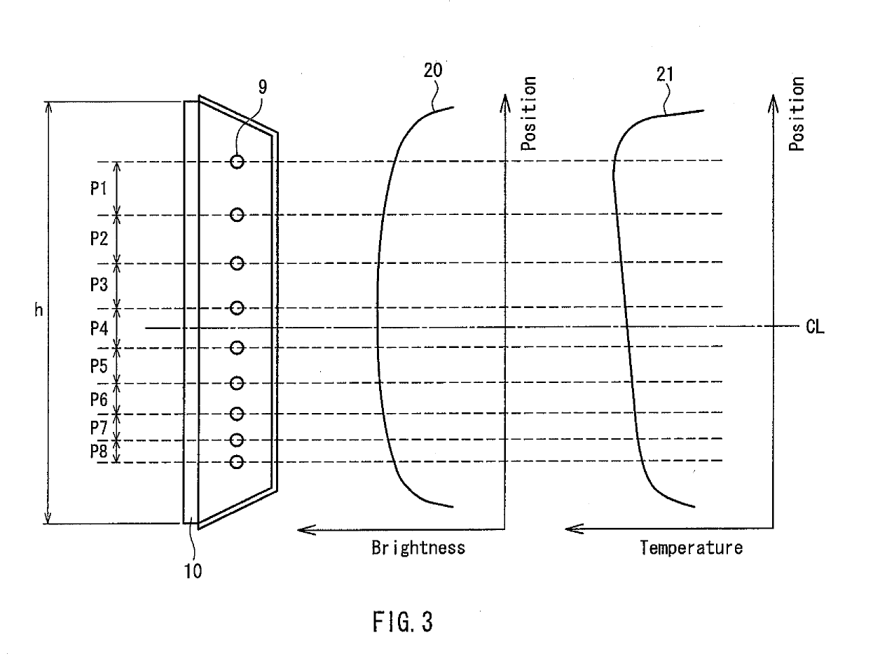

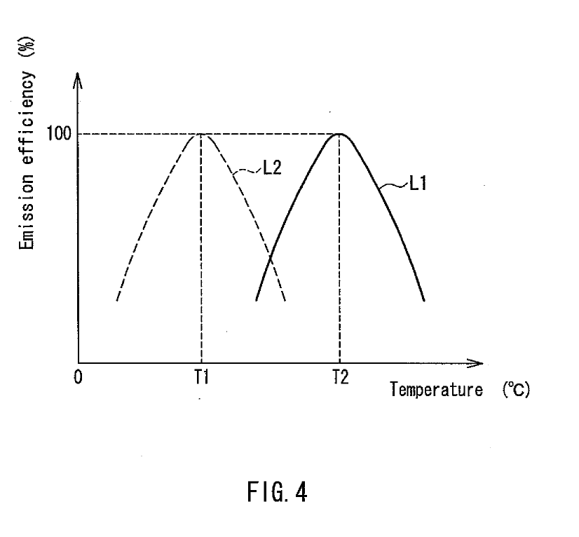

Hereinafter, the method for arranging the cold cathode fluorescent tubes 9 in the backlight device 8 of the present preferred embodiment will be described specifically also with reference to FIGS. 3 and 4.

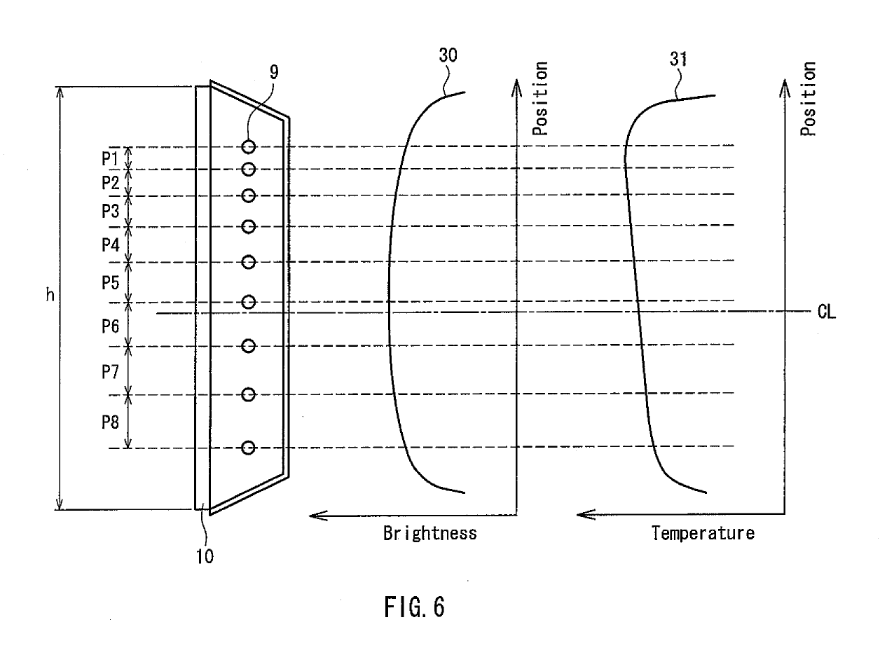

FIG. 3 is a view illustrating the specific arrangement, brightness distribution, and temperature distribution of cold cathode fluorescent tubes in the backlight device shown in FIG. 2, and FIG. 4 is a graph showing the specific emission characteristics of the cold cathode fluorescent tubes. In FIG. 3, the upper side and the lower side in the figure correspond to the upper side and the lower side in the vertical direction of the display surface 2a (FIG. 1), respectively (this also applies to FIG. 6 described later).

First, the emission characteristics of the cold cathode fluorescent tubes 9 will be described with reference to FIG. 4. In the cold cathode fluorescent tubes 9, the emission characteristics vary depending upon the diameter, the sealed amount of mercury, the composition or sealed amount of a sealed substance other than mercury, and the like, and as illustrated in FIG. 4, the cold cathode fluorescent tubes 9 have emission characteristics in which the emission efficiency changes depending upon the surrounding temperature (ambient temperature). More specifically, in the cold cathode fluorescent tube 9 having emission characteristics indicated by a curve L1 in FIG. 4, the emission efficiency is 100% and the emission amount and brightness reach maximum values at a temperature T2 (for example, 40° C.). Furthermore, in the cold cathode fluorescent tube 9 having emission characteristics indicated by a curve L2 in FIG. 4, the emission efficiency reaches 100% and the emission amount and brightness reach the maximum values at a temperature T1 (for example, 25° C.) lower than the temperature T2. As the cold cathode fluorescent tubes 9 of the present preferred embodiment, those which have the emission characteristics indicated by the curve L1, that is, those which have an emission efficiency of 100% at the relatively high ambient temperature T2 are used.

Furthermore, as shown in FIG. 3, in the backlight device 8 of the present preferred embodiment, in the case where the same predetermined current is supplied to all the cold cathode fluorescent tubes 9 under the same condition as that during the use of the television receiver 1, the temperature distribution inside the casing 8a (FIG. 2) is previously obtained by actual measurement, simulation, or the like. Furthermore, the temperature distribution is obtained when the ambient temperature of the television receiver 1 is set to be, for example, room temperature (25° C.). Then, as indicated by a curve 21 in FIG. 3, it is previously understood that the temperature of the upper side region in the vertical direction is higher than that of the lower side region in the vertical direction by, for example, about 15° C. to about 20° C., for example, during the use of the television receiver 1.

More specifically, it is previously determined that the above-mentioned temperature increase of about 15° C. to about 20° C., for example, occurs in the upper region of the casing 8a, compared with the temperature of the lower region, during the use of the television receiver 1 due to the influence (natural convection of heat) of each heat from the cold cathode fluorescent tubes 9, the driving circuit 14 (FIG. 2), and the inverter circuit 15 (FIG. 2), as well as the heat from the cold cathode fluorescent tubes 9 set in the casing 8a, which is understood as a temperature distribution during the use.

Furthermore, in the above temperature distribution, temperature data is acquired at positions marked in a predetermined unit (e.g., 2 cm) in a size (size h in the vertical direction of the diffusion plate 10) in the vertical direction of the light-emitting surface toward the lowest end, for example, with the uppermost end of the casing 8a being the standard. Specifically, for example, it is understood that the temperature of the uppermost end of the casing 8a is about 40° C. and the temperature of the lowermost end thereof is about 25° C., and it is understood that the temperatures at the respective positions between the uppermost end and the lowermost end are temperature values indicated by the curve 21.

On the other hand, in the cold cathode fluorescent tubes 9, as described above, those which have the emission characteristics indicated by the curve L1 in FIG. 4 are used. Therefore, pitches P1 to P8 of the respective two adjacent cold cathode fluorescent tubes 9 are set to decrease from the upper side to the lower side of the light-emitting surface in the nine cold cathode fluorescent tubes 9. That is, in the backlight device 8, the nine cold cathode fluorescent tubes 9 are provided so as to hold the following inequality (1).

P1>P2>P3>P4>P5>P6>P7>P8 (1)

More specifically, since the temperature of the uppermost end of the casing 8a is about 40° C., the cold cathode fluorescent tube 9 provided closest to the uppermost end emits light at an emission efficiency of almost 100%, for example. Furthermore, in the casing 8a, the temperature decreases from the upper side to the lower side in a direction perpendicular to the longitudinal direction (vertical direction) of the cold cathode fluorescent tubes 9. Therefore, the emission efficiency decreases gradually in the cold cathode fluorescent tubes 9. For this reason, the nine cold cathode fluorescent tubes 9 are arranged in a row in the perpendicular direction at pitches satisfying the above inequality (1). Consequently, in the backlight device 8 of the present embodiment, the brightness of the light-emitting surface can be set to be substantially uniform as indicated by the curve 20 in FIG. 3.

In the backlight device 8 of the present preferred embodiment configured as described above, the nine cold cathode fluorescent tubes 9 are arranged so that the pitch of the cold cathode fluorescent tubes 9 decreases gradually from the upper side to the lower side in the perpendicular direction, using the temperature distribution inside the casing 8a during the use of the television receiver 1 and the emission characteristics of the cold cathode fluorescent tubes (linear light sources) 9. That is, in the backlight device 8 of the present preferred embodiment, a plurality of cold cathode fluorescent tubes 9 are arranged at appropriate pitches respectively, in accordance with the emission characteristics (kind) and the setting number of the cold cathode fluorescent tubes 9 as well as the setting state of the backlight device 8 during the use of the television receiver 1 and the use environment such as the temperature distribution inside the casing 8a. Thus, in the backlight device 8 of the present preferred embodiment, the respective emission amounts of the cold cathode fluorescent tubes 9 can be made uniform easily. Accordingly, in the backlight device 8 of the present preferred embodiment, the brightness unevenness can be prevented easily from occurring in the above illumination light emitted toward the outside, unlike the above conventional example in which a plurality of cold cathode fluorescent tubes are arranged uniformly at a predetermined pitch.

Furthermore, in the backlight device 8 of the present preferred embodiment, the nine cold cathode fluorescent tubes 9 are arranged at unequal pitches in which all the pitches P1 to P8 are different from each other, so that the cold cathode fluorescent tubes 9 are arranged so as to be asymmetric with respect to a center line CL passing through the center in the perpendicular direction on the light-emitting surface. Consequently, in the backlight device 8 of the present preferred embodiment, the setting number of the cold cathode fluorescent tubes 9 can be reduced, and not only the power consumption of the backlight device 8 but also the power consumption of the television receiver 1 and the liquid crystal display apparatus 2 can be reduced easily. That is, in the backlight device 8 of the present preferred embodiment, since the occurrence of the brightness unevenness is prevented by setting the unequal pitches as described above. Therefore, unlike the case where the cold cathode fluorescent tubes are provided at an equal pitch, the cold cathode fluorescent tubes are not provided at unnecessary positions, and the occurrence of brightness unevenness can be prevented.

Furthermore, in the backlight device 8 of the present preferred embodiment, since the pitches of the cold cathode fluorescent tubes 9 can be determined appropriately, the occurrence of brightness unevenness in illumination light can be prevented easily irrespective of the setting number of the cold cathode fluorescent tubes 9. Thus, in the backlight device 8 of the present preferred embodiment, even when the setting number of the cold cathode fluorescent tubes 9 is increased in accordance with the enlargement of a screen, the increase in brightness, and the like in the television receiver 1 and the liquid crystal display apparatus 2, the occurrence of brightness unevenness can be prevented easily, and the television receiver 1 and the liquid crystal display apparatus 2 with high performance, in which the degradation in display quality is prevented, can be configured easily.

### Preferred Embodiment 2

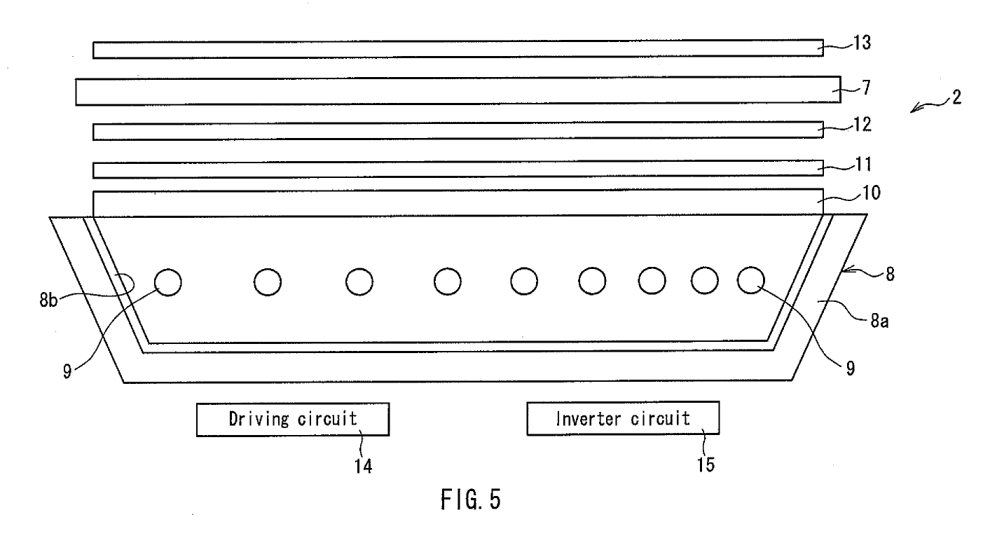

FIG. 5 is a view illustrating the configurations of main portions of a liquid crystal display apparatus according to Preferred Embodiment 2 of the present invention. In the figure, the present embodiment is different from Preferred Embodiment 1 mainly in that the pitch of the cold cathode fluorescent tube on the uppermost side of a light-emitting surface is set to be minimum, and the pitch increases gradually toward the lower side of the light-emitting surface. Elements common to those in Preferred Embodiment 1 are denoted with the same reference numerals as those therein, and the repeated description thereof will be omitted.

That is, as shown in FIG. 5, in the backlight device 8 of the present preferred embodiment, in the same way as in Preferred Embodiment 1 shown in FIG. 2, the nine cold cathode fluorescent tubes 9 are arranged in a row in the perpendicular direction so as to be parallel or substantially parallel to the light-emitting surface (surface of the diffusion plate 10 on the liquid crystal panel 7 side) at pitches different from each other. Furthermore, in the cold cathode fluorescent tubes 9, the pitches are determined using the temperature distribution during the use of the television receiver 1 and the emission characteristics of the cold cathode fluorescent tubes 9, whereby the occurrence of brightness unevenness is prevented (described later in detail).

Furthermore, in the backlight device 8 of the present preferred embodiment, the cold cathode fluorescent tubes 9 having the emission characteristics illustrated by the curve L2 in FIG. 4 are used. Specifically, as the cold cathode fluorescent tubes 9 of the present preferred embodiment, those which have an emission efficiency of 100% at the relatively low ambient temperature T1 are used.

Hereinafter, a method for arranging the cold cathode fluorescent tubes 9 in the backlight device 8 of the present preferred embodiment will be described specifically with reference to FIG. 6.

FIG. 6 is a view illustrating the specific arrangement, brightness distribution, and temperature distribution of the cold cathode fluorescent tubes in the backlight device shown in FIG. 5.

In FIG. 6, in the backlight device 8 of the present preferred embodiment, in the same way as in Preferred Embodiment 1, in the case where the same predetermined current is supplied to all the cold cathode fluorescent tubes 9 under the same condition as that during the use of the television receiver 1, the temperature distribution inside the casing 8a (FIG. 2) is previously obtained by actual measurement, simulation, or the like and understood.

More specifically, in the backlight device 8 of the present preferred embodiment, as indicated by a curve 31 in FIG. 6, it is previously understood that the temperature of the upper side region in the vertical direction is higher than that of the lower side region in the vertical direction by, for example, about 15° C. to about 20° C., for example, during the use of the television receiver 1, and the temperature value at each position also is previously understood. Specifically, it is understood that the temperature of the uppermost end of the casing 8a is about 40° C., and the temperature of the lower end is about 25° C., for example, and the temperature at each position between the uppermost end and the lowermost end is a temperature value indicated by the curve 31.

On the other hand, in the cold cathode fluorescent tubes 9, as described above, those which have the emission characteristics indicated by the curve L2 in FIG. 4 are used. Therefore, in the nine cold cathode fluorescent tubes 9, the pitches P1 to P8 of the respective two adjacent cold cathode fluorescent tubes 9 are determined so as to increase from the upper side to the lower side of the light-emitting surface. That is, in the backlight device 8, the nine cold cathode fluorescent tubes 9 are provided so as to hold the following inequality (2).

P1<P2<P3<P4<P5<P6<P7<P8 (2)

More specifically, since the temperature of the lowermost end of the casing 8a is about 25° C., the cold cathode fluorescent tube 9 provided closest to the lowermost end emits light at an emission efficiency of almost 100%, for example. Furthermore, in the casing 8a, the temperature increases from the lower side to the upper side in a direction perpendicular to the longitudinal direction (vertical direction) of the cold cathode fluorescent tubes 9. Therefore, the emission efficiency decreases gradually in the cold cathode fluorescent tubes 9. For this reason, the nine cold cathode fluorescent tubes 9 are arranged in a row in the perpendicular direction at pitches satisfying the above inequality (2). Consequently, in the backlight device 8 of the present preferred embodiment, the brightness of the light-emitting surface can be set to be substantially uniform as indicated by a curve 30 in FIG. 6.

Due to the above configuration, the backlight device 8 of the present preferred embodiment can exhibit functions and effects similar to those of Preferred Embodiment 1. More specifically, in the backlight device 8 of the present preferred embodiment, unlike the above conventional example, the occurrence of brightness unevenness in the above illumination light emitted toward the outside can be prevented easily. Furthermore, in the backlight device 8 of the present preferred embodiment, in the same way as in Preferred Embodiment 1, the nine cold cathode fluorescent tubes 9 are arranged at unequal pitches in which all the pitches P1 to P8 are different from each other. Therefore, the setting number of the cold cathode fluorescent tubes 9 can be reduced, and not only the power consumption of the backlight device 8 but also the power consumption of the television receiver 1 and the liquid crystal display apparatus 2 can be reduced easily.

Furthermore, in the backlight device 8 of the present preferred embodiment, in the same way as in Preferred Embodiment 1, even when the setting number of the cold cathode fluorescent tubes 9 is increased, the occurrence of brightness unevenness can be prevented easily, and the television receiver 1 and the liquid crystal display apparatus 2 with high performance, in which the degradation in display quality is prevented, can be configured easily.

### Preferred Embodiment 3

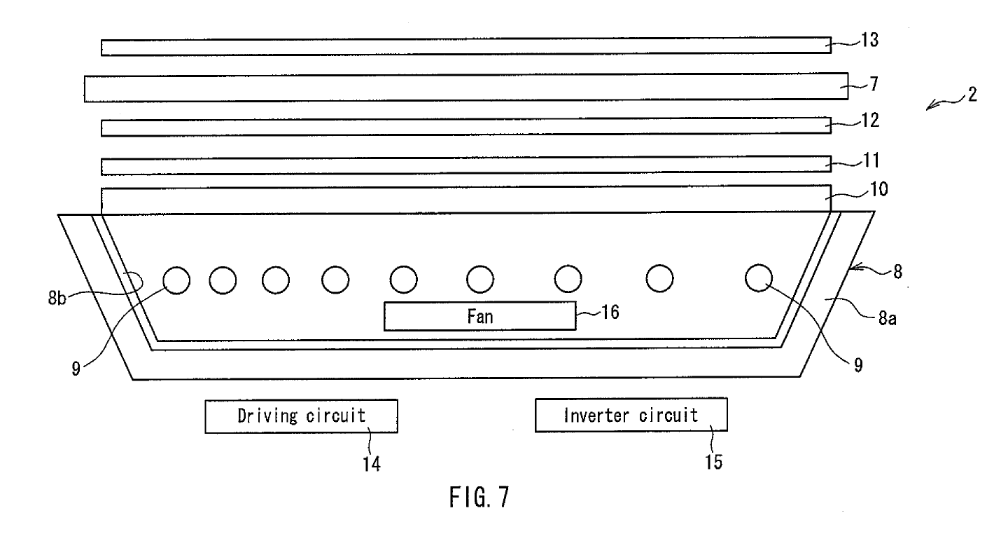

FIG. 7 is a view illustrating the configurations of main portions of a liquid crystal display apparatus according to Preferred Embodiment 3 of the present invention. In the figure, the present embodiment is different from Preferred Embodiment 1 mainly in that a fan is provided inside the casing, and the pitches of the cold cathode fluorescent tubes are determined using the temperature distribution including a temperature decrease by the fan and the emission characteristics of the cold cathode fluorescent tubes. Elements common to those in Preferred Embodiment 1 are denoted with the same reference numerals as those therein, and the repeated descriptions thereof will be omitted.

That is, as illustrated in FIG. 7, in the backlight device 8 of the present preferred embodiment, a fan 16 is provided as a cooling device inside the casing 8a. Then, in the backlight device 8 of the present preferred embodiment, the inside of the casing 8a can be cooled forcefully by rotating the fan 16. That is, an exhaust port and an aspiration port (not shown) are provided in the casing 8a, and when the fan 16 is rotated, air is circulated forcefully between the inside and the outside of the casing 8a, whereby the inner temperature of the casing 8a can be reduced. The exhaust port and the inspiration port are provided with a filter so as to minimize the invasion of dust and foreign matters into the inner space of the casing 8a.

Furthermore, in the backlight device 8 of the present preferred embodiment, as the temperature distribution during the use of the television receiver 1, the temperature decrease by the fan 16 is considered. Then, in the backlight device 8 of the present preferred embodiment, the pitches of the nine cold cathode fluorescent tubes are determined using the temperature distribution including the temperature decrease and the emission characteristics of the cold cathode fluorescent tubes 9.

Due to the above configuration, the backlight device 8 of the present preferred embodiment can exhibit functions and effects similar to those of Preferred Embodiment 1. Furthermore, in the backlight device 8 of the present preferred embodiment, a plurality of cold cathode fluorescent tubes 9 can be provided appropriately while the temperature decrease by the fan (cooling device) 16 is understood, and the occurrence of brightness unevenness can be prevented more easily and exactly.

### Preferred Embodiment 4

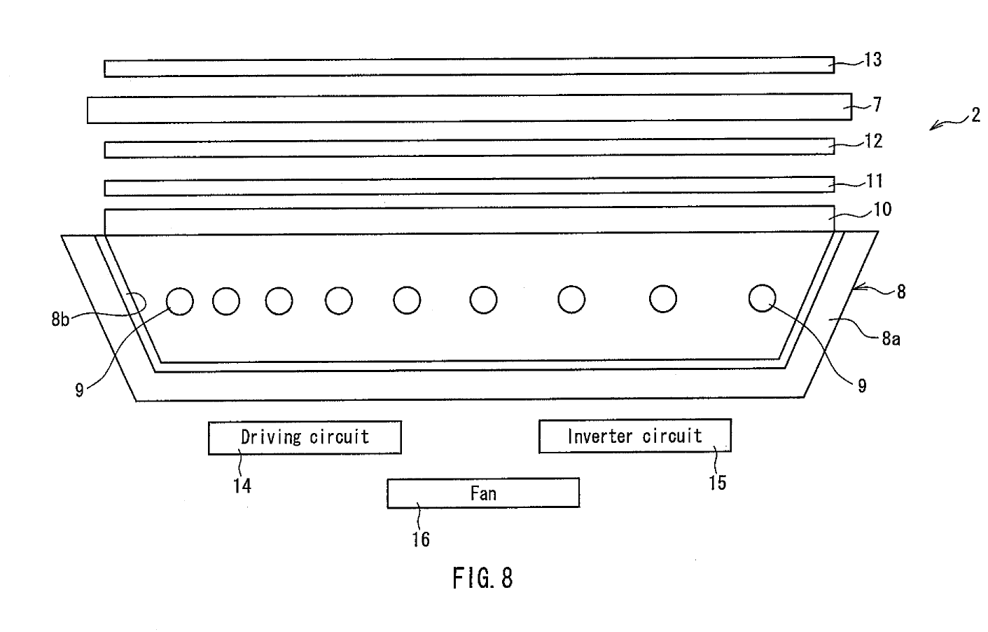

FIG. 8 is a view illustrating the configurations of main portions of a liquid crystal display apparatus according to Preferred Embodiment 4 of the present invention. In the figure, the present embodiment is different from Preferred Embodiment 1 mainly in that a fan is provided outside the casing, and the pitches of the cold cathode fluorescent tubes are determined using the temperature distribution including the temperature decrease by the fan and the emission characteristics of the cold cathode fluorescent tubes. Elements common to those in Preferred Embodiment 1 are denoted with the same reference numerals as those therein, and the repeated descriptions thereof will be omitted.

That is, as illustrated in FIG. 8, in the backlight device 8 of the present preferred embodiment, the fan 16 is provided as a cooing device outside the casing 8a. Then, in the backlight device 8 of the present preferred embodiment, the inside of the casing 8a can be cooled forcefully by rotating the fan 16. Furthermore, as illustrated in FIG. 8, the fan 16 is configured so as to cool the driving circuit 15 and the inverter circuit 16, as well as the inside of the casing 8a.

Furthermore, in the backlight device 8 of the present preferred embodiment, the temperature decrease by the fan 16 is considered as the temperature distribution during the use of the television receiver 1. Then, in the backlight device 8 of the present preferred embodiment, the pitches of the nine cold cathode fluorescent tubes 9 are determined using the temperature distribution including the above temperature decrease and the emission characteristics of the cold cathode fluorescent tubes 9.

Due to the above configuration, the backlight device 8 of the present embodiment can exhibit functions and effects similar to those of Preferred Embodiment 1. Furthermore, in the backlight device 8 of the present preferred embodiment, a plurality of cold cathode fluorescent tubes 9 respectively can be provided more appropriately while the temperature decrease by the fan (cooling device) 16 is understood, whereby the occurrence of brightness unevenness can be prevented more easily and more exactly.

### Preferred Embodiment 5

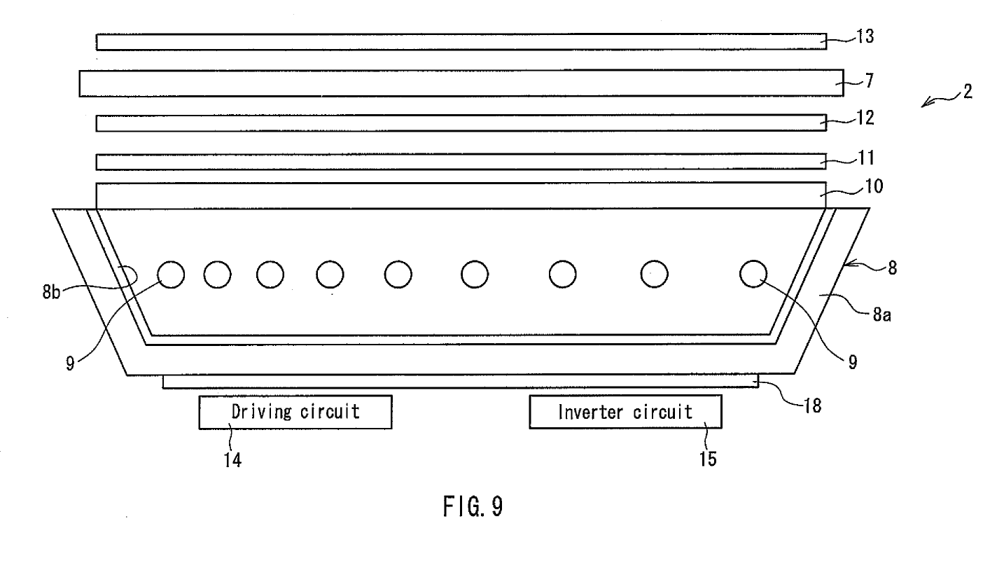

FIG. 9 is a view illustrating the configurations of main portions of a liquid crystal display apparatus according to Preferred Embodiment 5 of the present invention. In the figure, the present preferred embodiment is different from Preferred Embodiment 1 mainly in that fins are provided on the outside surface of the casing, and the pitches of the cold cathode fluorescent tubes are determined using the temperature distribution including the temperature decrease by the fins and the emission characteristics of the cold cathode fluorescent tubes. Elements common to those in Preferred Embodiment 1 are denoted with the same reference numerals as those therein, and the repeated descriptions thereof will be omitted.

Specifically, as illustrated in FIG. 9, in the backlight device 8 of the present preferred embodiment, a number of fins 18 are provided as cooling devices on the outside surface of the casing 8a. The fins 18 are included in a heat sink structure capable of cooling the inner space of the casing 8a and allow heat in the inner space of the casing 8a to be released naturally.

Furthermore, in the backlight device 8 of the present preferred embodiment, the temperature decrease by the fins 18 is considered as the temperature distribution during the use of the television receiver 1. In the backlight device 8 of the present preferred embodiment, the pitches of the nine cold cathode fluorescent tubes 9 are determined using the temperature distribution including the temperature decrease and the emission characteristics of the cold cathode fluorescent tubes 9.

Due to the above configuration, the backlight device 8 of the present preferred embodiment can exhibit functions and effects similar to those in Preferred Embodiment 1. In the backlight device 8 of the present preferred embodiment, a plurality of cold cathode fluorescent tubes 9 respectively can be provided more appropriately while the temperature decrease by the fins (cooling devices) 18 is understood, whereby the occurrence of brightness unevenness can be prevented more easily and more exactly.

As an alternative to the above description, the fan 16 and the fins 18 shown in FIGS. 7 to 9 may be combined appropriately to configure a cooling device for cooling the inside of the casing 8a.

### Preferred Embodiment 6

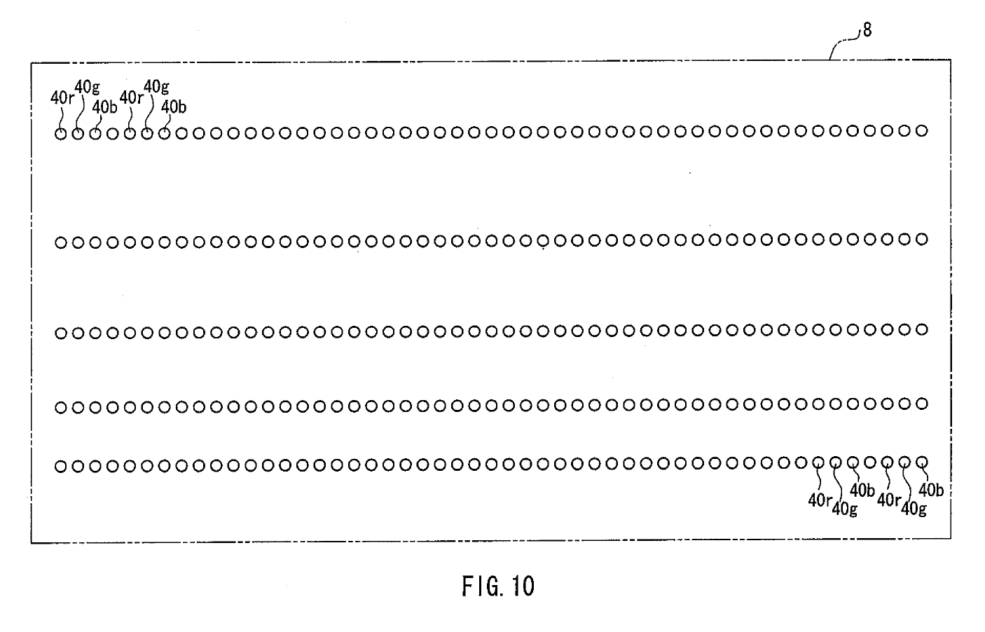

FIG. 10 is a view illustrating the configurations of main portions of a liquid crystal display apparatus according to Preferred Embodiment 6 of the present invention. In the figure, the present preferred embodiment is different from Preferred Embodiment 1 mainly in that light-emitting diodes are used in place of the cold cathode fluorescent tubes. Elements common to those in Preferred Embodiment 1 are denoted with the same reference numerals as those therein, and the repeated descriptions thereof will be omitted.

That is, as illustrated in FIG. 10, in the backlight device 8 of the present preferred embodiment, light-emitting diodes (LEDs) 40r, 40g, and 40b of RGB respectively emitting light of a red color (R), a green color (G), and a blue color (B) are arranged linearly in a row, and the light-emitting diode row is used as a linear light source. Furthermore, in the backlight device 8 of the present preferred embodiment, as illustrated in FIG. 10, five rows of light-emitting diodes are used, and these light-emitting diode rows are housed in the casing 8a. In the backlight device 8 of the present preferred embodiment, the pitch of each light-emitting diode row (linear light source) is determined using the temperature distribution inside the casing 8a during the use of the television receiver 1 and the emission characteristics of the light-emitting diodes 40r, 40g, and 40b, in the same way as in Preferred Embodiment 1.

Specifically, as illustrated in FIG. 10, in the backlight device 8 of the present preferred embodiment, the light-emitting diode rows are provided so that the pitch decreases gradually from the upper side to the lower side of the figure.

Due to the above configuration, the backlight device 8 of the present preferred embodiment can exhibit functions and effects similar to those in Preferred Embodiment 1. Furthermore, in the backlight device 8 of the present preferred embodiment, a plurality of light-emitting diodes 40r, 40g, 40b arranged linearly in a row are used. Therefore, even in the backlight device 8 with a relatively small light-emitting surface, the above-mentioned occurrence of brightness unevenness can be prevented easily, and the backlight device 8 capable of enlarging a color reproducing range can be configured easily.

### Preferred Embodiment 7

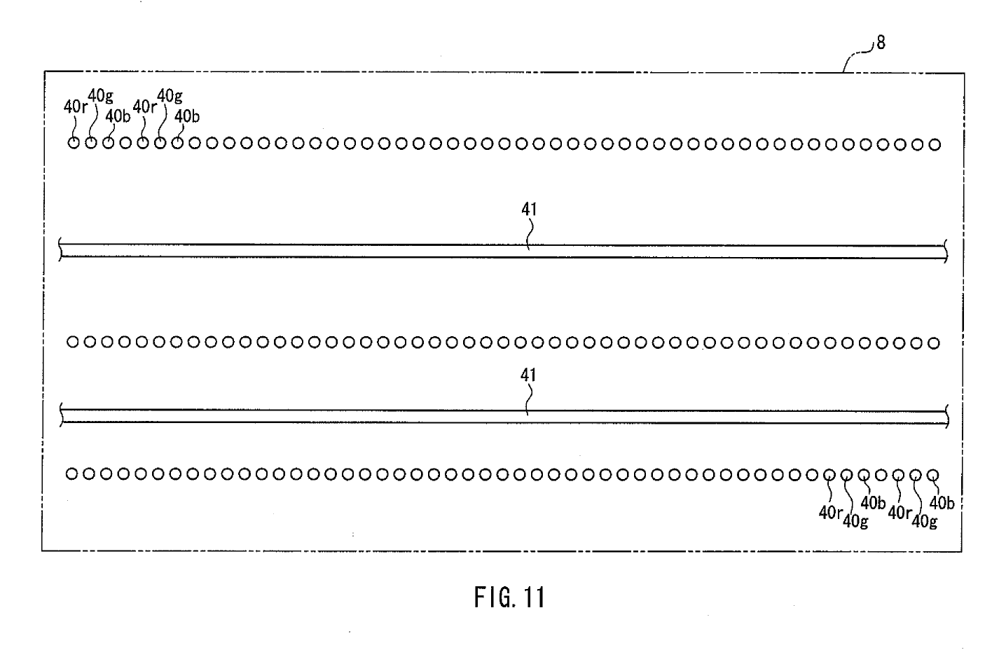

FIG. 11 is a view illustrating the configurations of main portions of a liquid crystal display apparatus according to Preferred Embodiment 7 of the present invention. In the figure, the present preferred embodiment is different from Preferred Embodiment 1 mainly in that light-emitting diodes and hot cathode fluorescent tubes are used in place of the cold cathode fluorescent tubes. Elements common to those in Preferred Embodiment 1 are denoted with the same reference numerals as those therein, and the repeated descriptions thereof will be omitted.

That is, as illustrated in FIG. 11, in the backlight device 8 of the present preferred embodiment, the light-emitting diodes (LEDs) 40r, 40g, 40b of RGB respectively emitting light of a red color (R), a green color (G), and a blue color (B) are arranged linearly in a row, and the light-emitting diode row is used as a linear light source. Furthermore, in the backlight device 8 of the present preferred embodiment, as illustrated in FIG. 11, three rows of light-emitting diodes are used, and hot cathode fluorescent tubes 41 are arranged between the respective two adjacent light-emitting diode rows. The light-emitting diode rows and the hot cathode fluorescent tubes 41 are housed in the casing 8a. Furthermore, as the hot cathode fluorescent tubes 41, those which are excellent in an emission efficiency and have a diameter of about 5 mm to about 26 mm, for example, are preferably used.

In the backlight device 8 of the present preferred embodiment, the pitches of the light-emitting diode rows (linear light sources) and the hot cathode fluorescent tubes 41 are determined using the temperature distribution inside the casing 8a during the use of the television receiver 1 and the emission characteristics of the light-emitting diodes 40r, 40g, 40g, and the emission characteristics of the hot cathode fluorescent tubes 41, in the same way as in Preferred Embodiment 1.

Specifically, as illustrated in FIG. 11, in the backlight device 8 of the present preferred embodiment, the light-emitting diode rows and the hot cathode fluorescent tubes 41 are provided so that the pitch decreases gradually from the upper side to the lower side of the figure.

Due to the above configuration, the backlight device 8 of the present preferred embodiment can exhibit functions and effects similar to those in Preferred Embodiment 1. Furthermore, in the backlight device 8 of the present preferred embodiment, the light-emitting diode rows and the hot cathode fluorescent tubes 41 are arranged alternately, so that the backlight device 8 capable of enlarging a color reproducing range can be configured more easily.

As an alternative to the above description, the cold cathode fluorescent tubes and the light-emitting diode rows may be arranged alternately, or the cold cathode fluorescent tubes or hot cathode fluorescent tubes, and the light-emitting diode rows are arranged alternately by a plurality of rows.

The above preferred embodiments are all shown for illustrative purposes and not limiting. The technical range of the present invention is defined by the scope of the claims, and the configuration recited therein and all the changes within the equivalent range also fall within the technical range of the present invention.

For example, in the above description, the case where the present invention is preferably applied to a transmission type liquid crystal display apparatus has been described. However, the backlight device of the present invention is not limited thereto, and can be applied to various kinds of display apparatuses equipped with a non-light-emitting type display portion for displaying information such as images and characters using light from a light source. Specifically, the backlight device of the present invention can be used preferably in a semi-transmission type liquid crystal display apparatus or a projection type display apparatus.

Furthermore, as an alternative to the above description, the present invention can be used preferably as a film viewer that irradiates an X-ray photograph with light, a light box that irradiates a negative or the like with light to make it easy to recognize the negative visually, or a backlight device of a light-emitting device for lighting up a signboard or advertisement set on a wall surface in a station premise.

Furthermore, as an alternative to the above description, the case has been described in which the nine cold cathode fluorescent tubes (linear light sources) are preferably arranged in a row in a direction perpendicular or substantially perpendicular to the longitudinal direction so that the nine cold cathode fluorescent tubes (linear light sources) are parallel to the light-emitting surface, and the pitch of the cold cathode fluorescent tubes decreases or increases gradually from the lower side to the upper side of the light-emitting surface. However, the present invention is not limited as long as a plurality of linear light sources are arranged in such a manner that the longitudinal directions thereof are parallel or substantially parallel to each other and the pitch of the linear light source provided on one end in a direction perpendicular or substantially perpendicular to the longitudinal directions with respect to a center line passing through the center in the perpendicular direction of the light-emitting surface is differentiated from the pitch of the linear light source provided on the other end in the perpendicular direction with respect to the center line.

It is preferred that a plurality of cold cathode fluorescent tubes are arranged, determining the pitches of the cold cathode fluorescent tubes, using the temperature distribution when the cold cathode fluorescent tubes are lit by an inverter circuit (lighting circuit) and the emission characteristics of the cold cathode fluorescent tubes. That is, in such a configuration, a plurality of cold cathode fluorescent tubes respectively can be provided more appropriately under the condition that the temperature distribution and the emission characteristics are understood, whereby the occurrence of brightness unevenness can be prevented more easily and more exactly.

Furthermore, it is more preferred that the pitches of the cold cathode fluorescent tubes are determined using the temperature distribution including the temperature increase caused by the heat generated in the driving circuit (external device) driving the liquid crystal panel and the above emission characteristics as in the above preferred embodiments. More specifically, in this case, the occurrence of brightness unevenness can be prevented more easily and more exactly while the adverse effects of the change in ambient temperature caused by the heat generated from the external device are eliminated exactly. In other words, a plurality of cold cathode fluorescent tubes are located at positions different from each other, using the temperature distribution including the temperature increase caused by a heat-generation source (disturbance) on the liquid crystal panel side on which the backlight device is incorporated, as well as a heat-generation source (inner factor) such as the cold cathode fluorescent tubes intrinsically owned by the backlight device, which is preferred in that the adverse effect of disturbance can be eliminated more exactly.

Furthermore, in the above description, although the case of illustrating the driving circuit of the liquid crystal panel as the external device of the backlight device has been described. However, the external device of the present invention is not limited thereto and includes various electric components, electric circuits, and the like that are attached to the backlight device appropriately and generate heat during the use to constitute a heat-generation source. Specifically, considering the temperature increase caused by the heat generated by a driver IC to be mounted on one of a pair of substrates included in the liquid crystal panel, the pitches of the cold cathode fluorescent tubes also can be determined appropriately.

Furthermore, as an alternative to the above description, a plurality of cold cathode fluorescent tubes can be arranged in a row under the condition that they are inclined at a predetermined angle with respect to the light-emitting surface, or can be arranged in such a manner that the distance between the cold cathode fluorescent tubes and the reverse surface of the diffusion plate opposed to the light-emitting surface is changed on a cold cathode fluorescent tube basis.

It is preferred that a plurality of cold cathode fluorescent tubes respectively are arranged in a row in a perpendicular or substantially perpendicular direction so as to be parallel or substantially parallel to the light-emitting surface as in the above preferred embodiments, because the pitches of the cold cathode fluorescent tubes can be determined simply, and the occurrence of brightness unevenness can be prevented more easily.

Furthermore, in the above description, the case has been described where a plurality of cold cathode fluorescent tubes are arranged without providing a cold cathode fluorescent tube on a center line of the light-emitting surface. However, present invention is not limited thereto, and the cold cathode fluorescent tube may be provided on the center line. More specifically, the cold cathode fluorescent tube is provided on the center line, and the cold cathode fluorescent tubes may be arranged on one end and the other end in the perpendicular direction at pitches different from each other with respect to the cold cathode fluorescent tube on the center line.

Furthermore, in each of Preferred Embodiments 1 to 5, the case of using cold cathode fluorescent tubes has been described. However, it also is possible to use the hot cathode fluorescent tubes shown in Preferred Embodiment 7. Furthermore, another discharge fluorescent tube such as a xenon fluorescent tube also can be used. In the case of using such a discharge fluorescent tube, a backlight device with less power consumption can be configured easily at a low cost. Furthermore, it is preferred to use the cold cathode fluorescent tube with a diameter of about 3 mm to about 4 mm and the hot cathode fluorescent tube with a diameter of about 5 mm to about 26 mm, for example, as described above, because cold cathode fluorescent tubes or hot cathode fluorescent tubes having an excellent emission efficiency are used for each linear light source, whereby a backlight device with less power consumption can be configured more easily at a low cost.

Furthermore, as an alternative to the above description, the inverter circuit (lighting circuit) may light a plurality of linear light sources sequentially in a direction from one end to the other end or from the other end to one end in the perpendicular direction. In the case of such a configuration, a backlight device enabling so-called scan drive can be configured, in which a plurality of linear light sources respectively can be lit successively in the above direction. Consequently, the display performance in the display device and the television receiver can be enhanced easily.

Furthermore, as an alternative to the above description, the inverter circuit (lighting circuit) may supply currents having values different from each other to a plurality of linear light sources respectively to light each linear light source. In the case of such a configuration, the respective emission amounts of a plurality of linear light sources can be made uniform more easily, and the occurrence of brightness unevenness can be prevented more simply. It is preferred that each of a plurality of linear light sources is lit with the same supply current value, as in each of the above preferred embodiments, because the decrease in emission efficiency of each linear light source and the complication and enlargement of the lighting circuit can be prevented.

Furthermore, in the above description, the case of applying the present invention to the liquid crystal display apparatus to be set so that the display surface is parallel to the vertical direction has been described. However, the present invention also can be applied to a liquid crystal display apparatus and a television receiver having a display surface inclined at a predetermined angle with respect to the vertical direction.

In the backlight device, the display apparatus, and the television receiver according to various preferred embodiments of the present invention, a backlight device capable of preventing the occurrence of brightness unevenness easily is used, so that the present invention is effective for a backlight device having excellent emission quality and a display apparatus and a television receiver with high performance having excellent display quality.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-17. (canceled)

18: A backlight device, comprising:
a plurality of linear light sources; and
a light-emitting surface emitting light from the linear light sources; wherein
the plurality of linear light sources respectively are arranged so that longitudinal directions thereof are parallel or substantially parallel to each other; and
the plurality of linear light sources are arranged such that a pitch of the linear light source provided on one end in a direction perpendicular or substantially perpendicular to the longitudinal directions with respect to a center line passing through a center in the perpendicular or substantially perpendicular direction of the light-emitting surface is differentiated from a pitch of the linear light source provided on the other end in the perpendicular or substantially perpendicular direction with respect to the center line.

19: The backlight device according to claim 18, wherein the plurality of linear light sources respectively are arranged in a row in the perpendicular or substantially perpendicular direction so as to be parallel or substantially parallel to the light-emitting surface.

20: The backlight device according to claim 18, further comprising a lighting circuit arranged to light the plurality of linear light sources, wherein pitches of the plurality of linear light sources are determined using a temperature distribution when the linear light sources are lit by the lighting circuit and emission characteristics of the linear light sources.

21: The backlight device according to claim 20, wherein the pitches of the plurality of linear light sources are determined using the temperature distribution including a temperature increase caused by heat generated by an external device and the emission characteristics of the linear light sources.

22: The backlight device according to claim 20, further comprising a housing containing the plurality of linear light sources, wherein the pitches of the plurality of linear light sources are determined using the temperature distribution including a temperature decrease caused by a cooling device provided inside the housing and the emission characteristics of the linear light sources.

23: The backlight device according to claim 20, further comprising a housing containing the plurality of linear light sources, wherein the pitches of the plurality of linear light sources are determined using the temperature distribution including a temperature decrease caused by a cooling device provided outside the housing and the emission characteristics of the linear light sources.

24: The backlight device according to claim 20, further comprising a housing containing the plurality of linear light sources, wherein the pitches of the plurality of linear light sources are determined using the temperature distribution including a temperature decrease caused by a cooling device attached to an outside surface of the housing and the emission characteristics of the linear light sources.

25: The backlight device according to claim 18, wherein each of the plurality of linear light sources is a cold cathode fluorescent tube or a hot cathode fluorescent tube.

26: The backlight device according to claim 18, wherein each of the plurality of linear light sources is a cold cathode fluorescent tube with a diameter of about 3 mm to about 4 mm.

27: The backlight device according to claim 18, wherein each of the plurality of linear light sources is a hot cathode fluorescent tube with a diameter of about 5 mm to about 26 mm.

28: The backlight device according to claim 18, wherein a plurality of light-emitting diodes arranged linearly in a row are used as each of the plurality of linear light sources.

29: The backlight device according to claim 18, wherein, as the plurality of linear light sources, cold cathode fluorescent tubes or hot cathode fluorescent tubes, and a plurality of light-emitting diodes arranged linearly in a row are arranged alternately by one row or by a plurality of rows.

30: The backlight device according to claim 20, wherein the lighting circuit is arranged to light the plurality of linear light sources sequentially in a direction from one end to the other end or from the other end to one end of the perpendicular or substantially perpendicular direction.

31: The backlight device according to claim 20, wherein the lighting circuit is arranged to light each linear light source by supplying current values different from each other to the plurality of linear light sources, respectively.

32: The backlight device according to claim 18, wherein an optical member that provides predetermined emission characteristics with respect to light emitted from the light-emitting surface is provided above the light-emitting surface.

33: A display apparatus comprising the backlight device according to claim 18.

34: A television receiver comprising the display apparatus according to claim 33.
